(19) United States
(12) Patent Application Publication
(10) Pub. No.: US 2025/0123643 A1
(43) Pub. Date: Apr. 17, 2025

(54) POWER SUPPLY CIRCUIT AND DETECTION APPARATUS

(71) Applicant: FCL COMPONENTS LIMITED, Tokyo (JP)

(72) Inventor: Kazuyoshi EBATA, Tokyo (JP)

(73) Assignee: FCL COMPONENTS LIMITED, Tokyo (JP)

(21) Appl. No.: 18/906,971

(22) Filed: Oct. 4, 2024

(30) Foreign Application Priority Data
Oct. 16, 2023 (JP) 2023-178392

(51) Int. Cl. G05F 1/56

(52) U.S. Cl. CPC G05F 1/56

(57) ABSTRACT

A power supply circuit includes a first regulator that includes a first input terminal to which a first voltage is input, a first output terminal from which a second voltage is output, and a first adjustment terminal, and adjusts the second voltage based on a voltage of the first adjustment terminal, a second regulator that includes a second input terminal to which the first voltage is input and a second output terminal from which a third voltage is output, and a differential amplifier circuit that outputs, to the first adjustment terminal, a signal corresponding to a difference between the third voltage and a fourth voltage at a first node between a plurality of first resistors connected in series between the first output terminal and a reference potential lower than the second voltage.

### CROSS-REFERENCE TO RELATED APPLICATION

This application is based upon and claims the benefit of priority of the prior Japanese Patent Application No. 2023-178392 filed on Oct. 16, 2023, the entire contents of which are incorporated herein by reference.

### FIELD

A certain aspect of the embodiments is related to a power supply circuit and a detection apparatus.

### BACKGROUND

There has been known a power supply circuit using two regulators for supplying two DC voltages as an internal circuit of an electronic device or the like. Note that the technique related to the present disclosure is disclosed in Patent Documents 1 and 2 (Document 1: Japanese Laid-open Patent Publication No. 2004-102676, and Document 2: Japanese Laid-open Patent Publication No. 2007-14176).

### SUMMARY

In one aspect of embodiments, there is provided a power supply circuit including: a first regulator that includes a first input terminal to which a first voltage is input, a first output terminal from which a second voltage is output, and a first adjustment terminal, and adjusts the second voltage based on a voltage of the first adjustment terminal; a second regulator that includes a second input terminal to which the first voltage is input and a second output terminal from which a third voltage is output; and a differential amplifier circuit that outputs, to the first adjustment terminal, a signal corresponding to a difference between the third voltage and a fourth voltage at a first node between a plurality of first resistors connected in series between the first output terminal and a reference potential lower than the second voltage.

### BRIEF DESCRIPTION OF DRAWINGS

FIG. 1 is a circuit diagram of a power supply circuit according to a first embodiment.

FIG. 2 is a circuit diagram of a regulator in the first embodiment.

FIG. 3 is a circuit diagram of a power supply circuit according to a first comparative example.

FIG. 4 is a circuit diagram of a power supply circuit according to a second comparative example.

FIG. 5 is a circuit diagram of the first embodiment used for simulation.

FIG. 6 is a diagram illustrating voltage V2 with respect to time of a third comparative example in simulation.

FIG. 7 is a diagram illustrating voltage V2 with respect to time of the first embodiment in simulation.

FIG. 8 is a block diagram of a detection apparatus according to a second embodiment.

FIGS. 9A to 9C are diagrams illustrating signal with respect to time in the first embodiment.

### DESCRIPTION OF EMBODIMENTS

There is a case where two DC voltages are supplied so that the voltage ratio of the two DC voltages becomes a constant ratio. A method of supplying two DC voltages by a resistance voltage division from a power supply voltage is conceivable. However, in this method, the supplied DC voltage varies due to a current flowing through a load. It is conceivable to use two regulators and supply two DC voltages. However, an error occurs between the reference voltages of the regulators. Therefore, it is difficult to set the voltage ratio of the two DC voltages to a constant ratio.

The present disclosure has been made in view of the above problems, and it is an object of the present disclosure to provide a power supply circuit and a detection apparatus that provide a stable voltage.

Hereinafter, a description will be given of the embodiment of the present disclosure with reference to the drawings.

### First Embodiment

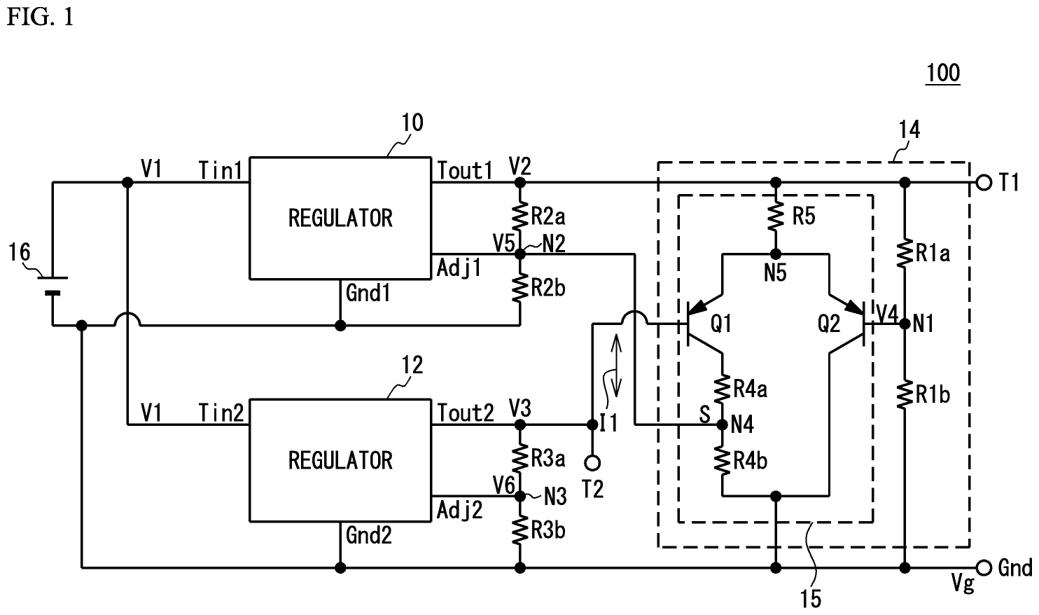

FIG. 1 is a circuit diagram of a power supply circuit according to a first embodiment. A power supply circuit 100 includes regulators 10 and 12 and an error amplifying circuit 14. The regulator 10 includes terminals Tin1, Tout1, Adj1 and Gnd1. The regulator 12 has terminals Tin2, Tout2, Adj2 and Gnd2. The regulators 10 and 12 are, for example, LDO (Low Drop Out) type linear regulators. A reference potential Vg (for example, 0 V, which is a ground potential) is supplied to the terminal Gnd. A DC power supply 16 supplies a voltage V1.

The voltage V1 (first voltage) is input to the terminal Tin1 (first input terminal) of the regulator 10 (first regulator). The regulator 10 converts the voltage V1 into a voltage V2 (second voltage) and outputs the voltage V2 to the terminal Tout1 (first output terminal). The terminal Gnd1 of the regulator 10 is electrically connected to the terminal Gnd. A plurality of second resistors (resistors R2a and R2b) are connected in series between the terminal Tout1 and the reference potential Vg. A node N2 (second node) between the resistors R2a and R2b is electrically connected to a terminal Adj1 (first adjustment terminal) of the regulator 10. The voltage at node N2 is a voltage V5. The regulator 10 adjusts the voltage V2 based on the voltage V5 of the terminal Adj1. The voltage V2 is output from the terminal Tout1 to the terminal T1.

The voltage V1 is input to the terminal Tin2 (second input terminal) of the regulator 12 (second regulator). The regulator 12 converts the voltage V1 into a voltage V3 (third voltage) and outputs the voltage V3 to the terminal Tout2 (second output terminal). The terminal Gnd2 of the regulator 12 is electrically connected to the terminal Gnd. A plurality of fifth resistors (resistors R3a and R3b) are connected in series between the terminal Tout2 and the reference potential Vg. A node N3 (fourth node) between the resistors R3a and R3b is electrically connected to the terminal Adj2 (second adjustment terminal) of the regulator 12. The voltage at the node N3 is a voltage V6. The regulator 12 adjusts the voltage V3 based on the voltage V6 (fifth voltage) of the terminal Adj2. The voltage V3 is output from the terminal Tout2 to the terminal T2.

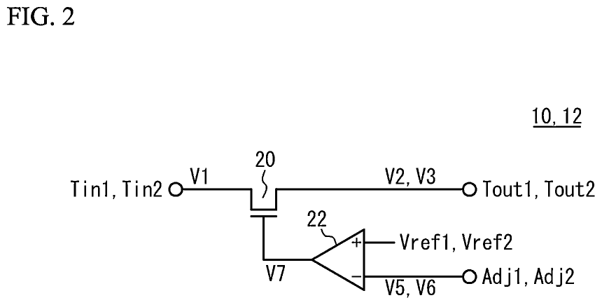

FIG. 2 is a circuit diagram of a regulator according to the first embodiment. Each of the regulators 10 and 12 includes a transistor 20 and a second differential amplifier circuit 22. The transistor 20 is connected in series between the terminal Tin1 (and Tin2) and the terminal Tout1 (and Tout2). The transistor 20 is, for example, a MOSFET (Metal Oxide Semiconductor Field Effect Transistor), which is an NchFET. The drain of the transistor 20 is electrically connected to the terminal Tin1 (and Tin2), and the source is electrically connected to the terminal Tout1 (and Tout2). The reference voltage Vref1 (and Vref2) and the signal of the terminal Adj1 (and Adj2) are input to the second differential amplifier circuit 22. The output terminal of the second differential amplifier circuit 22 is connected to a control terminal (for example, a gate) of the transistor 20.

In FIG. 1, when the voltage V5 (and V6) input to the terminal Adj1 (and Adj2) becomes higher than the reference voltage Vref1 (and Vref2), the voltage V7 output from the output terminal of the second differential amplifier circuit 22 becomes negative. This restricts the current flowing between the drain and source of the transistor 20, and increases the resistance between the drain and source of the transistor 20. This increases the voltage drop across transistor 20 and lowers voltage V2 (and V3). When the voltage V5 (and V6) becomes lower than the reference voltage Vref1 (and Vref2), the voltage V7 output from the output terminal of the second differential amplifier circuit 22 becomes positive. Therefore, the current flowing between the drain and the source of the transistor 20 increases, and the resistance between the drain and the source of the transistor 20 decreases. This reduces the voltage drop across transistor 20 and increases the voltage V2 (and V3). In this way, the regulators 10 and 12 adjust the voltage V2 (and V3) based on the voltage V5 (and V6) at the terminals Adj1 (and Adj2).

The resistances of the resistors R2a, R2b, R3a, and R3b in FIG. 1 are respectively denoted by R2a, R2b, R3a, and R3b. At this time, when there is no error amplifying circuit 14 (that is, when there is no connecting line between a node N4 and the node N2), the voltage V2=Vref1×(R2a+R2b)/R2b, and the voltage V3=Vref2×(R3a+R3b)/R3b are satisfied. In the case where V3 is V2/N, the resistance values of the resistors R2a, R2b, R3a, and R3b may be determined so that the ratio N=(Vref1×R3b×(R2a+R2b))/(Vref2×R2b×(R3a+R3b)). However, each of the resistors to be used has an error, and the voltage ratio between the voltages V3 and V2 is affected by the accuracy of the reference voltages Vref1 and Vref2. Therefore, by adding the error amplifying circuit 14 (that is, in the case where there is a connection line between the node N4 and the node N2), the accuracy of the value of the ratio N between the voltages V3 and V2 can be improved. When the error amplifying circuit 14 is added, the accuracy of the ratio between V3 and V2 is determined mostly by the accuracy of the resistance values of the resistors R1a and R1b. Therefore, by using highly accurate resistors, for example, highly accurate resistors with an error of 1% or 0.5% or less, as the resistors R1a and R1b, the ratio N can be made to be accurate to 1% or 0.5% or less of a target value even if the accuracy of the reference voltages Vref1 and Vref2 and the accuracy of other resistors are not good (for example, even if the accuracy is 5%).

Although the LDO type linear regulator has been described as an example of the regulators 10 and 12, the regulators 10 and 12 may be other types of, for example, switching regulators, and the input voltage of the regulator 10 and the input voltage of the regulator 12 may be different from each other. In particular, the regulator 12 may be a regulator that does not include the terminal Adj2.

Referring back to FIG. 1, the error amplifying circuit 14 includes resistors R1a and R1b and a first differential amplifying circuit 15 (differential amplifying circuit). A plurality of first resistors (R1a and R1b) are connected in series between the terminal T1 and the reference potential Vg. The voltage of the node N1 (first node) between the resistors R1a and R1b is V4 (fourth voltage).

The first differential amplifier circuit 15 includes transistors Q1 (first transistor), Q2 (second transistor), resistors R4a (fourth resistor), R4b (third resistor), and R5. The transistors Q1 and Q2 are, for example, PNP bipolar transistors. The emitters of the transistors Q1 and Q2 are connected in common to, for example, a node N5. A resistor R5, for example, is connected between the node N5 and the terminal T1. The resistor R5 functions as a current source. The collector of the transistor Q1 is electrically connected to the terminal Gnd through the resistors R4a and R4b in series. The collector of the transistor Q2 is electrically connected to, for example, the terminal Gnd. The base of the transistor Q1 is electrically connected to the terminal Tout2. The base of the transistor Q2 is electrically connected to the node N1. The voltages V3 and V4 are input to the bases of the transistors Q1 and Q2, respectively. The node N4 between resistors R4a and R4b is electrically connected to the node N2 and terminal Adj1.

When the voltage V4 becomes higher than the voltage V3, the potential of the node N4 tends to become higher. As a result, a current I1 flows from the node N4 to the node N2, and the voltage V5 at the node N2 becomes high. Therefore, the regulator 10 reduces the voltage V2. When the voltage V4 becomes lower than the voltage V3, the potential of the node N4 tends to become lower. As a result, the current I1 flows from the node N2 to the node N4, and the voltage V5 at the node N2 becomes low. Therefore, the regulator 10 increases the voltage V2. The resistance values of the resistors R1a and R1b are referred to as R1a and R1b, respectively. Thereby, the ratio of the voltage V2 to the voltage V3 is a desired ratio determined from the resistance values of the resistors R1a and R1b.

Assuming that the target value of the ratio of the voltage V2 to the voltage V3 is N=V2/V3, (R1a+R1b)/R1b may be set to be the ratio N. Although there is a manufacturing error in the resistance value, in FIG. 1, the accuracy of the ratio between the voltages V3 and V2 is mostly determined by the accuracy of the resistance values of the resistors R1a and R1b. Therefore, only the resistors R1a and R1b are highly accurate resistors, for example, highly accurate resistors of 1% or 0.5% or less. Thus, even if the accuracy of the reference voltages Vref1 and Vref2 and the accuracy of the other resistors are not good (for example, even if the accuracy is 5%), the ratio N can be set to an accuracy of 1% or 0.5% or less of the target value. It is preferable that (R1a+R1b)/R1b is 0.95 times or more and 1.05 times or less N. This makes it possible to reduce the error in the voltage ratio between the voltages V2 and V3.

If the resistances of the resistors R4a and R4b are too high, the voltage V5 at the node N2 hardly moves even if the difference between the voltages V3 and V4 becomes large. On the other hand, if the resistance values of the resistors R4a and R4b are too low, the change in the voltage V5 at the node N2 becomes large with respect to the difference between the voltages V3 and V4. Since oscillation occurs in the first differential amplifier circuit 15 and the second differential amplifier circuit 22, the resistance values of the resistors R4a and R4b are set appropriately so as to operate as described above.

A resistor may be provided between the transistor Q2 and the terminal Gnd. The first differential amplifier circuit 15 does not need a differential output, and a resistor need not be provided between the transistor Q2 and the reference potential Vg. This can reduce the number of parts and the cost.

The transistors Q1 and Q2 may be PchFETs, NPN bipolar transistors or NchFETs. When the transistors Q1 and Q2 are NPN bipolar transistors or NchFETs, the resistor R5 is provided between the terminal Gnd and the emitter or source of the transistors Q1 and Q2, and resistors R4a and R4b are provided between the transistor Q1 and the terminal T1. When the voltage at the node N2 is close to the voltage V2, a circuit may be configured by using the NPN bipolar transistors or NchFETs as the transistors Q1 and Q2.

### First Comparative Example

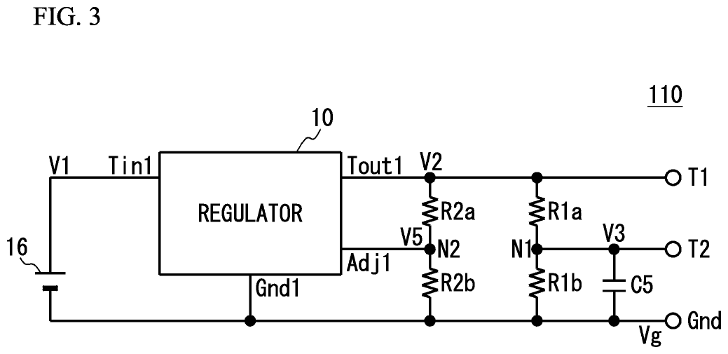

FIG. 3 is a circuit diagram of a power supply circuit according to a first comparative example. A power supply circuit 110 of the first comparative example is not provided with the regulator 12. The node N1 between the resistors R1a and R1b is connected to the terminal T2. By setting the resistance values of the resistors R1a and R1b to be the same as the resistance values of the resistors R1a and R1b in the first embodiment, the voltage V3 can be generated at the node N1. A capacitor C5 for noise cut is connected between the node N1 and the terminal Gnd. The other configuration of the first comparative example is the same as that of the first embodiment.

In the first comparative example, the voltages V2 and V3 vary depending on the current consumption between the terminal T1 or T2 and the terminal Gnd. As a result, the voltage ratio between the voltages V2 and V3 is not constant. When the frequency of the change in the voltage V2 is high, the capacitor C5 can cut the noise. However, when the frequency of the change in the voltage V2 is as low as, for example, about 10 Hz, the noise cannot be cut. This makes it impossible to keep the ratio of the voltages V2 and V3 constant.

### Second Comparative Example

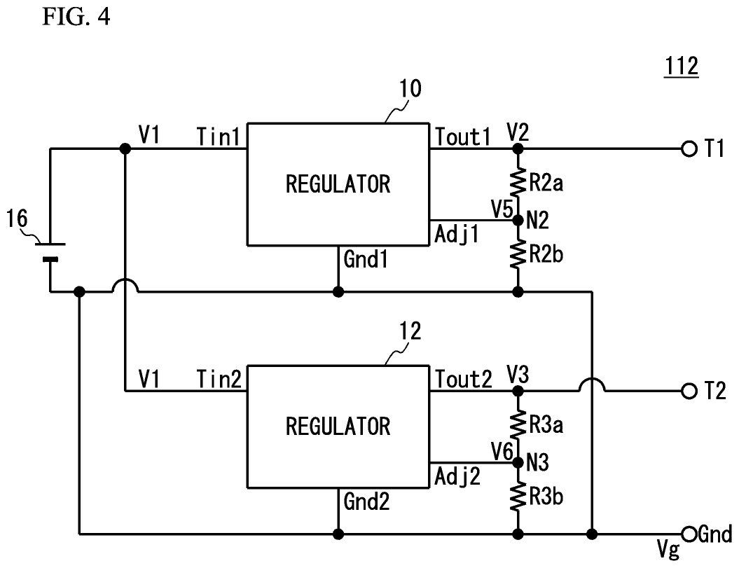

FIG. 4 is a circuit diagram of a power supply circuit according to a second comparative example. A power supply circuit 112 of the second comparative example 2 is not provided with the error amplifying circuit 14. The regulator 10 adjusts the voltage V2 by using the voltage V5 and the reference voltage Vref1 illustrated in FIG. 2. The regulator 12 adjusts the voltage V3 using the voltage V6 and the reference voltage Vref2 illustrated in FIG. 2. The other configuration of the second comparative example is the same as that of the first embodiment.

In the second comparative example, the regulators 10 and 12 adjust the voltages V2 and V3 so that the voltages V2 and V3 do not vary, respectively. Therefore, the voltages V2 and V3 can be prevented from varying due to the current consumption. However, there is a manufacturing error between the reference voltage Vref1 of the regulator 10 and the reference voltage Vref2 of the regulator 12. For example, a linear regulator is inexpensive, but has a large error in the reference voltage. Therefore, in order to set the ratio of the voltages V2 and V3 to a desired ratio, the resistance values of the resistors R2a, R2b, R3a, and R3b are adjusted for each of the regulators 10 and 12, which increases the manufacturing cost.

On the other hand, in the first embodiment, as illustrated in FIG. 1, the first differential amplifier circuit 15 outputs a signal S corresponding to the difference between the voltage V4 at the node N1 between the resistors R1a and R1b and the voltage V3, which is the output voltage of the regulator 12, to the terminal Adj1 (adjustment terminal) of the regulator 10. In this way, the voltage V2 is adjusted based on the difference between the voltage V3, and the voltage V4 obtained by dividing the voltage V2 and the reference potential Vg by resistance. This makes it possible to set the voltage ratio between the voltages V2 and V3 to a constant ratio within the range of the error in the resistance values of the resistors R1a and R1b. By selecting resistors having an allowable resistance value of 1% or less, 0.5% or less, or 0.2% or less as the resistors R1a and R1b, the error in the voltage ratio between the voltages V2 and V3 can be reduced.

The terminal Adj1 is electrically connected to the node N2 between the resistors R2a and R2b. Thereby, the voltage V5 divided by the resistors R2a and R2b is finely adjusted by the difference between the voltage V3 and the voltage V4. The regulator 10 adjusts the voltage V2 based on the fine adjusted voltage V5. This makes it possible to set the voltage ratio between the voltages V2 and V3 to a constant ratio.

In the first differential amplifier circuit 15, the transistor Q1 (first transistor) and the transistor Q2 (second transistor) are connected in parallel between the terminal Tout1 and the reference potential Vg. The voltage V3 is input to the base (control terminal) of the transistor Q1, and the voltage V4 is input to the base (control terminal) of the transistor Q2. The resistor R4b (third resistor) is connected in series to the transistor Q1 between the terminal Tout2 and the reference potential Vg, and is connected in parallel to the transistor Q2. The node N4 (third node) between the resistor R4b and the transistor Q1 is electrically connected to the node N2. This allows a current to flow from the node N4 to the node N2 based on the difference between the voltages V2 and V4. Therefore, the voltage V5 at the node N2 can be finely adjusted.

A resistor R4a (fourth resistor) is connected in series between the transistor Q1 and the resistor R4b between the terminal Tout1 and the reference potential Vg. This makes it possible to finely adjust the voltage V5 at the node N2 regardless of the direction of the current flowing between the nodes N4 and N2.

### [Simulation]

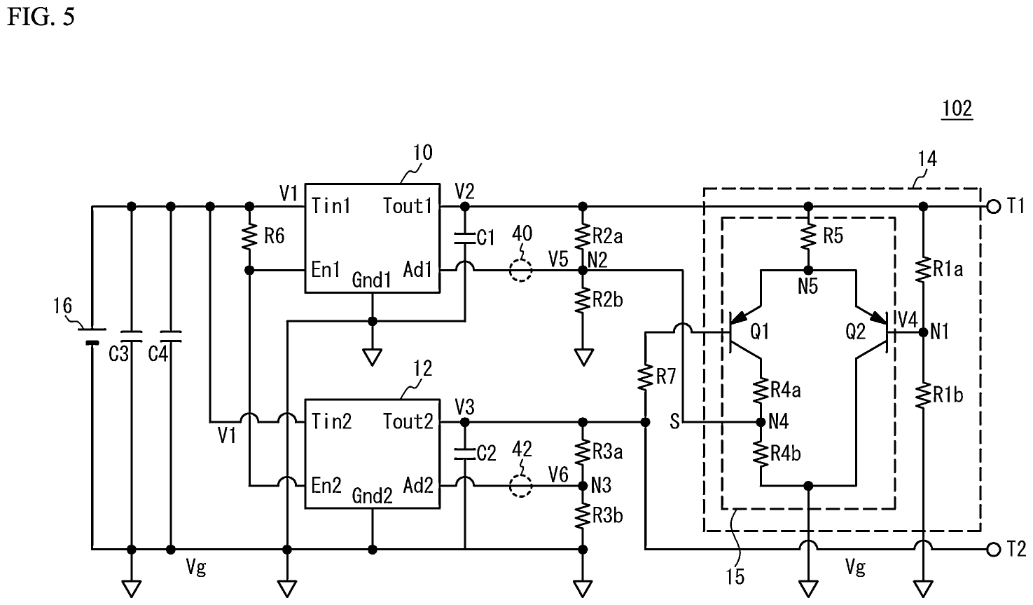

The simulation was performed assuming errors of the reference voltages Vref1 and Vref2 of the regulators 10 and 12. FIG. 5 is a circuit diagram of the first embodiment used for the simulation. In the power supply circuit 102 according to the first embodiment used for the simulation, the regulators 10 and 12 are provided with terminals En1 and En2. The terminals En1 and En2 are terminals to which the regulators 10 and 12 are activated and deactivated, respectively, when a high level and a low level are input. Capacitors C3 and C4 are connected in parallel to the DC power supply 16. A resistor R6 is connected in common between the terminal Tin1 and the terminals En1 and En2. A resistor R7 is connected between the terminal Tout2 and the base of the transistor Q1. A capacitor C1 is connected between the terminal Tout1 and the reference potential Vg. A capacitor C2 is connected between the terminal Tout2 and the reference potential Vg. The other circuit configuration in FIG. 5 are the same as those in FIG. 1.

In a third comparative example in the simulation, the error amplifying circuit 14 of FIG. 5 is not provided.

Table 1 illustrates the resistance values of the respective resistors in FIG. 5.

TABLE 1

| RESISTOR | R1a | R1b | R2a | R2b | R3a | R3b | R4a | R4b | R5 | R6 | R7 |
|---|---|---|---|---|---|---|---|---|---|---|---|
| RESISTANCE | 1 | 1 | 47 | 15 | 16 | 15 | 6.8 | 6.8 | 4.7 | 10 | 1 |
| VALUE [kΩ] | | | | | | | | | | | |

Table 2 illustrates the capacitance values of the respective capacitors in FIG. 5.

TABLE 2

| CAPACITOR | C1 | C2 | C3 | C4 |
|---|---|---|---|---|
| CAPACITANCE | 1 | 1 | 22 | 10 |
| VALUE [μF] | | | | |

Table 3 illustrates the respective voltages in FIG. 5.

TABLE 3

| | V1 | V2 | V3 | Vref1 | Vref2 |
|---|---|---|---|---|---|
| VOLTAGE [V] | 5 | 3.3 | 1.65 | 1.0 | 1.0 |

The regulators 10 and 12 are regulators in which the reference voltages Vref1 and Vref2 are 0.8 V. However, since there is no simulation model in which the reference voltages Vref1 and Vref2 are 0.8 V, the reference voltages Vref1 and Vref2 are set to 1.0 V. A DC power supply 40 for boosting the voltage V5 by 0.2 Vis provided between the node N2 and the terminal Adj1, and a DC power supply 42 for boosting the voltage V6 by 0.2 Vis provided between the node N3 and the terminal Adj2. The boosted voltage of the DC power supply 40 was fixed at 0.20 V, and the boosted voltage of the DC power supply 42 was a sine wave changing by ±0.02 V around 0.20 V. The value ±0.02 V represents the error of the reference voltage Vref1 in terms of the deviation of the boosted voltage of the DC power supply 42. The period of the sine wave was 0.5 msec.

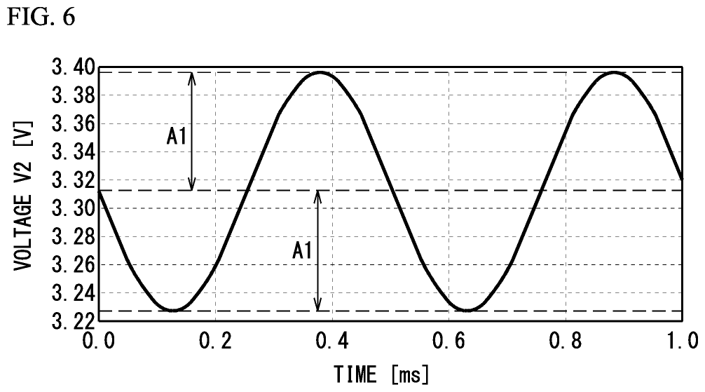

FIG. 6 is a diagram illustrating the voltage V2 with respect to time in the simulation of the third comparative example. The voltage V2 is a sine wave centered around 3.3 V, and the difference A1 between the center value and the maximum value or the minimum value is about 0.1 V. The voltage V3 is 1.6562 V. As described above, in the third comparative example, if it is assumed that the reference voltage Vref1 of the regulator 10 changes by 0.02 V, the voltage V2 changes by +0.1 V.

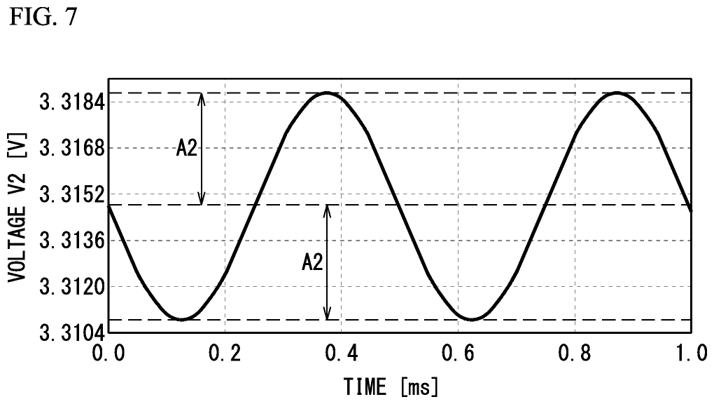

FIG. 7 is a diagram illustrating the voltage V2 with respect to time of the first embodiment in the simulation. The voltage V2 is a sine wave centered around 3.315 V, and the difference A2 between the center value and the maximum value or the minimum value is about 0.004 V. The voltage V2 is 1.6562 V. As described above, in the first embodiment, even if it is assumed that the reference voltage Vref1 of the regulator 10 changes by 0.02 V, the change in the voltage V2 is 0.004 V. In this way, in the first embodiment, even if there is an error between the reference voltage Vref1 of the regulator 10 and the reference voltage Vref2 of the regulator 12, the voltage V3 can be set as the midpoint of the voltage V2.

### Second Embodiment

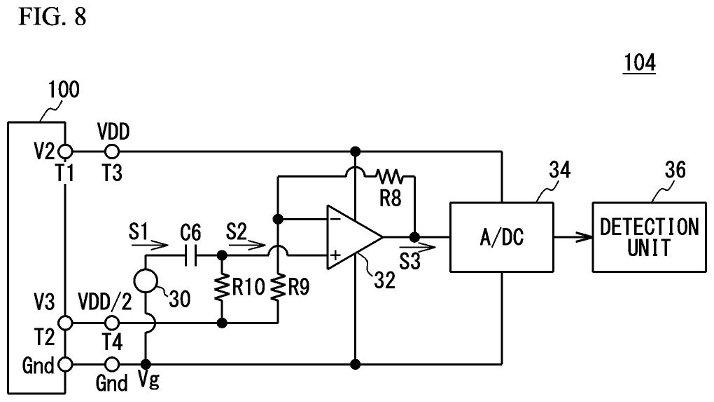

A second embodiment is an example in which the first embodiment is used for a detection apparatus. FIG. 8 is a block diagram of a detection apparatus according to a second embodiment. A detection apparatus 104 of the second embodiment mainly includes a power supply circuit 100, a sensor 30, an operational amplifier 32, an A/DC (Analog Digital Converter) 34, and a detection unit 36. The power supply circuit 100 is the power supply circuit of the first embodiment, and outputs voltages V2 and V3 to terminals T1 and T2, respectively. V3=V2/2 is satisfied. The voltage V2 is supplied from the power supply circuit 100 to a terminal T3 as a power supply voltage VDD. The voltage V3 is supplied from the power supply circuit 100 to a terminal T4 as a voltage VDD/2, which is the midpoint of the power supply voltage VDD. The reference potential Vg (for example, 0 V as a ground potential) is supplied to the terminal Gnd.

An output signal S1 of the sensor 30 is input to the positive end of the operational amplifier 32 via a capacitor C6. The positive end of the operational amplifier 32 is connected to the terminal T4 through a resistor R10. The terminal T4 is input to the negative terminal of the operational amplifier 32 via a resistor R9. An output signal S3 of the operational amplifier 32 is input to the A/DC (analog/digital converter) 34 and fed back to the negative terminal via a resistor R8. The reference potential Vg and the power supply voltage VDD are supplied to the A/DC 34. The digital signal output from the A/DC 34 is output to the detection unit 36. The detecting unit 36 is a processor such as a CPU (Central Processing Unit), for example, and processes the digital signal.

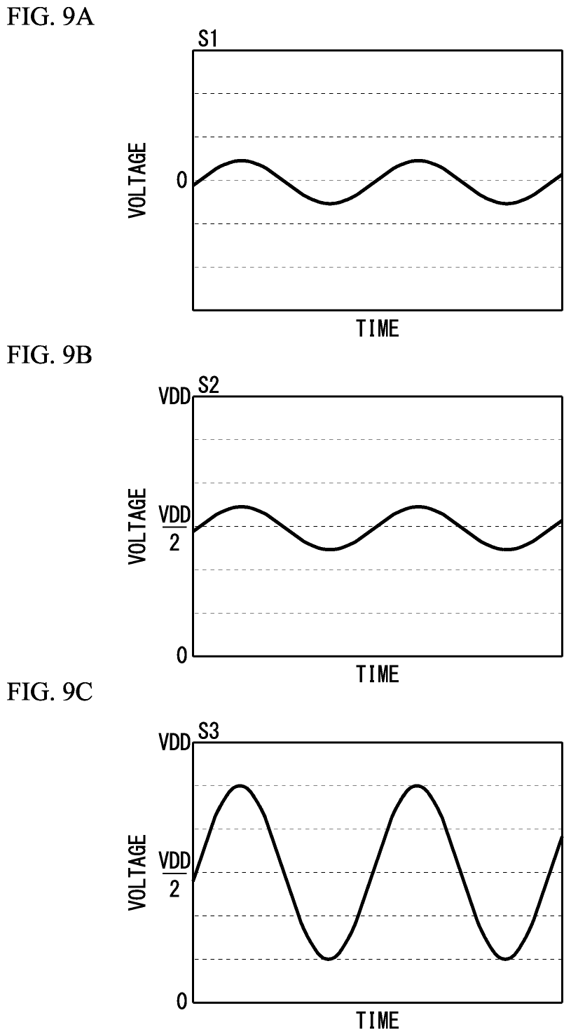

FIGS. 9A to 9C are diagrams illustrating signals with respect to time in the second embodiment. Actual signals S1 to S3 are not necessarily sine waves, but sine waves will be used for description. The sensor 30 is, for example, a millimeter wave laser sensor or a vibration sensor. As illustrated in FIG. 9A, the output signal S1 with respect to the reference potential Vg of the sensor 30 has a waveform oscillating in the positive direction and the negative direction around 0 V, and has a frequency of, for example, several Hz to several 100 Hz. The capacitor C6 removes a DC component of the signal S1.

The voltage VDD/2 is supplied to the positive end of the operational amplifier 32 through the resistor R10. As a result, as illustrated in FIG. 9B, the signal S2 input to the positive end has a waveform that oscillates around the voltage VDD/2. The voltage VDD/2 is supplied to the negative terminal. Thus, the operational amplifier 32 amplifies the difference between the signal S2 and the voltage VDD/2 with the voltage VDD/2 as a reference. The gain of the operational amplifier 32 is set by the resistance values of the resistors R8 and R9. As illustrated in FIG. 9C, the operational amplifier 32 amplifies the signal S2 around the voltage VDD/2 and outputs the amplified signal S3.

The A/DC 34 digitizes the voltage between the reference potential Vg and the power supply voltage VDD at equal intervals. For example, when the resolution of the A/DC 34 is 16 bits, the resolution is 0 x 0000 when the signal S3 is 0 V, which is the reference potential Vg, and the resolution is 0 x FFFF when the signal S3 is the power supply voltage VDD. When the signal S3 is the voltage VDD/2, the voltage is 0 x 7FFF or 0 x 8000.

When the voltage V3 at the terminal T4 is slightly shifted from the voltage VDD/2 to be the voltage VDD/2+α, the operational amplifier 32 amplifies the difference between the signal S2 and the voltage VDD/2+α with the voltage VDD/2+α as a reference. Therefore, the zero point of the signal S3 is greatly shifted from the voltage VDD/2. This narrows the dynamic range. Alternatively, the signal processing in the detecting section 36 is affected. As described above, in the second embodiment, it is important that the voltage of the terminal T4 is the voltage VDD/2.

Therefore, the voltage V2 of the power supply circuit 100 of the first embodiment is set to the power supply voltage VDD of the A/DC 34 (A/D converter), and the operational amplifier 32 (operational amplifier circuit) amplifies the output signal S2 of the sensor 30 with the voltage V3 (VDD/2) of the power supply circuit 100 as a reference. Thus, the A/DC 34 can perform A/D conversion with the voltage VDD/2 as the midpoint. The voltage V3 may not be exactly ½ of the voltage V2, and the voltage V3 may be 0.475 times or more and 0.525 times or less, 0.49 times or more and 0.51 times or less, or 0.495 times or more and 0.505 times or less the voltage V2. In order to perform A/D conversion of information from a sensor with higher accuracy, higher voltage accuracy is required in order to increase the gain of the operational amplifier, for example. However, even when a general-purpose LDO type linear regulator is used, the output voltage accuracy can be improved by utilizing the present embodiment and, for example, improving the resistance accuracy of the resistors R1a and R1b.

Although the power supply circuit 100 of the first embodiment is used in the detecting device 104, the power supply circuit 100 may be used in an electronic device other than the detecting device 104.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A power supply circuit comprising:
a first regulator that includes a first input terminal to which a first voltage is input, a first output terminal from which a second voltage is output, and a first adjustment terminal, and adjusts the second voltage based on a voltage of the first adjustment terminal;
a second regulator that includes a second input terminal to which the first voltage is input and a second output terminal from which a third voltage is output; and
a differential amplifier circuit that outputs, to the first adjustment terminal, a signal corresponding to a difference between the third voltage and a fourth voltage at a first node between a plurality of first resistors connected in series between the first output terminal and a reference potential lower than the second voltage.

2. The power supply circuit according to claim 1, wherein
the first adjustment terminal is connected to a second node between a plurality of second resistors connected in series between the first output terminal and the reference potential.

3. The power supply circuit according to claim 1, wherein
the differential amplifier circuit includes:
a first transistor that has a control terminal to which the third voltage is input;
a second transistor that has a control terminal to which the fourth voltage is input, the first transistor and the second transistor being connected in parallel between the first output terminal and the reference potential; and
a third resistor that is connected in series to the first transistor between the first output terminal and the reference potential and connected in parallel to the second transistor;
wherein a third node between the third resistor and the first transistor is electrically connected to the first adjustment terminal.

4. The power supply circuit according to claim 3, further comprising:
a fourth resistor that is connected in series with the first transistor and the third resistor between the first output terminal and the reference potential, and connected between the first transistor and the third resistor;
wherein the third node is a node between the third resistor and the fourth resistor.

5. The power supply circuit according to claim 1, wherein
(R1a+R1b)/R1b is 0.95 times or more and 1.05 times or less N,
where R1a is a resistance value between the first node and the first output terminal, R1b is a resistance value between the first node and the reference potential, and N is a ratio of the second voltage to the third voltage.

6. The power supply circuit according to claim 1, wherein
the second regulator has a second adjustment terminal, and adjusts the third voltage based on a fifth voltage at a fourth node between a plurality of fifth resistors connected in series between the third voltage and the reference potential.

7. A detection apparatus comprising:
a power supply circuit including:
a first regulator that includes a first input terminal to which a first voltage is input, a first output terminal from which a second voltage is output, and a first adjustment terminal, and adjusts the second voltage based on a voltage of the first adjustment terminal;
a second regulator that includes a second input terminal to which the first voltage is input and a second output terminal from which a third voltage is output; and
a differential amplifier circuit that outputs, to the first adjustment terminal, a signal corresponding to a difference between the third voltage and a fourth voltage at a first node between a plurality of first resistors connected in series between the first output terminal and a reference potential lower than the second voltage;
a sensor;
an operational amplifier circuit that amplifies a difference between an output of the sensor and the third voltage; and
an A/D converter to which an output of the operational amplifier circuit is input and that uses the second voltage as a power supply voltage.
